(19) United States
(12) Patent Application Publication
(10) Pub. No.: US 2008/0026929 A1
(43) Pub. Date: Jan. 31, 2008

(54) METHOD AND APPARATUS FOR PRODUCTION OF A COMPOUND HAVING SUBMICRON PARTICLE SIZE AND A COMPOUND PRODUCED BY THE METHOD

(76) Inventors: Henrik Jensen, Frederiksberg (DK); Erik Gydesen Sogaard, Esbjerg (DK); Steen Brummerstedt Iversen, Vedbaek (DK)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/584,301

(22) PCT Filed: Dec. 23, 2003
(86) PCT No.: PCT/DK03/00934

§ 371 Date: Aug. 7, 2007

(51) Int. Cl. C04B 35/00; C04B 35/51; C04B 35/56; C04B 35/58; C04B 35/624

(52) U.S. Cl. 501/87; 425/10; 65/17.2

(57) ABSTRACT

The invention relates to an improved method of manufacturing a compound having a sub-micron primary particle size such as a metal compound such as metal oxides, metaloxy hydroxides metal hydroxides, metal carbides, metal nitrides, metal carbonitrides, metal borides, electroceramics and other such compound, said method comprising the steps of: introducing a solid reactor filling material in a reactor, introducing a metal-containing precursor, a semi-metal-containing precursor, a metal-containing oxide or a semi-metal-containing oxide in said reactor, introducing a reactant or a substitution source into the said reactor, and introducing a supercritical solvent into the said reactor. These steps result in the formation of said compound in the proximity of the said solid reactor filling material.

### BACKGROUND OF THE INVENTION

The production of sub-micron particles is gaining in importance as more and more advantages of using sub-micron particles are being realized and demonstrated in a very broad range of applications spanning catalysts, coatings, structural components, ceramics, electroceramics, bio-compatible materials and many others.

However, a general problem with the industrial application of such particles is often the prohibitive costs of the materials as well as the need to have the particle characteristics such as shape, size and crystal phase well defined and controlled.

One way to obtain the product specification in a less costly manner is to make use of a sol-gel process which is a fairly simple low-cost process, taking place at low temperatures. The process parameters can be varied to obtain different properties, [Moran et al., 1999], and/or several additional processing steps can be introduced, such as calcining, to obtain for example special crystalline phases.

In general terms the sol gel process allows for the production of metal compounds such as metal oxides, metaloxy hydroxides, metal hydroxides, metal carbides, metal nitrides, metal carbonitrides, and metal borides among others. The process allows for the production of particles of a relatively simple composition such as TiO₂, or a considerably more complex composition such as exemplified by the electroceramics such as: BaTiO₃, MgTiO₃, PbTiO₃, Bi₄Ti₃O₁₂, LaTiO₇, Pb(Zr_{0.52}Ti_{0.48})O₃ [PZT], Pb(Mg_{1/3}Nb_{2/3})O₃ [PMN], Ba(Mg_{1/3}Ta_{2/3})O₃ [BMT] [Komarneni et al., 1999]

In general terms the sol gel process also allows for the production of ceramic compounds such as metal oxides, metaloxy hydroxides, metal hydroxides, metal carbides, metal nitrides, metal carbonitrides, and metal borides among others. The process allows for the production of particles of a relatively simple composition such as TiO₂, or a considerably more complex composition such as exemplified by the electroceramics such as: BaTiO₃, MgTiO₃, PbTiO₃, Bi₄Ti₃O₁₂, LaTiO₇, Pb(Zr_{0.52}Ti_{0.48})O₃ [PZT], Pb(Mg_{1/3}Nb_{2/3})O₃ [PMN], Ba(Mg_{1/3}Ta_{2/3})O₃ [BMT]

By producing metal oxides, metaloxy hydroxides, or metal hydroxides in a traditional sol-gel process [Livage et al., 1998] an amorphous product is obtained with a finite particle size of 1 μm to 10 μm. In the traditional sol-gel process, it is necessary to calcine the product at high temperatures for up to 24 hours in order to obtain a crystalline product. In addition to a higher energy-usage, this has the unfortunate effect within, for example catalysis applications, that the specific surface area is decreased by up to 80% [Andersen, 1975].

By using supercritical fluids as solvents in the sol-gel processes rather than the traditional alcohols, a significantly lower particle size in the nanometer range can be obtained. This is believed to be due to the higher reaction rate obtained in supercritical media [Jung & Perrut, 2001].

Over the last decades the synthesis of ceramics and metal oxides in supercritical fluids (for example supercritical CO₂) has been further developed so as to improve upon the particle characteristics, for example in terms of chemical homogeneity and structure and morphology [Jung & Perrut, 2001].

The lowest temperature at which particulate material of the anatase phase of TiO₂ has been produced in the prior art is 250° C. [Robbe et al. 2003]. This result, however, is obtained by first producing an amorphous TiO₂ under supercritical conditions and then calcining the amorphous product at 250° C.

The above mentioned process for producing the anatase phase at 250° C. is based on a patent [Sarrade et al., 2002], which describes the production of metal oxides and silicon oxides in a supercritical process. This process yields amorphous oxides, which in order to become crystalline needs further calcination. These oxides have a particle size of 100 nm to 1000 nm.

A continuous supercritical production process [Reverchon et al. 2002] also results in amorphous nano-sized Titanium Hydroxide particles.

[Sievers and Karst, 1997] also describe a method for the supercritical production of 100 nm to 650 nm amorphous particles.

Yet another method for producing nano-sized metal oxides, metaloxy hydroxides, or metal hydroxides is by applying supercritical drying, where an already produced powder is inserted into a chamber, where it is dried in supercritical conditions by for example supercritical CO₂. This process is described in [Yamanis, 1989], where different metal oxides are subjected to post-production supercritical drying, resulting in the obtainment of very large specific surface areas. This method also allows for the production of crystalline products without reducing the specific surface, as shown in [Yoda et al. 2001]. Yoda et al. demonstrate that the supercritical drying can increase the specific surface area of TiO₂ and SiO₂ up to values of 700-900 m²/g.

Commercial crystalline TiO₂ is mainly made by flame oxidation synthesis of TiCl₄ in a H₂/O₂ flame. An example of this is the commercially available Degussa P25 (Degussa GmbH, Germany) which has a particle size of ˜ 35 nm and consists of a mixture of rutile phase and anatase phase of TiO₂. Compared to the sol-gel process, it is difficult to vary the process parameters and thus the result, in flame oxidation synthesis [Brinker 1990]. In addition, it is not possible to produce a pure anatase phase, as it is less stable than the rutile phase. Flame synthesis is also used to produce, for example, silicon dioxide, alumina, and zirconium dioxide [Brinker, 1990]

Doped titania by a sol-gel method is in [Traversa et al., 2001] showed to give nano-sized Ta— and Nb-doped TiO₂. The Ta— and Nb doped TiO₂ is synthesized from titanium isopropoxide and tantalum pentaethoxide, Ta(OEt)₅, and niobium pentaethoxide, Nb(OEt)₅. The XRD analysis showed that the precipitates dried at 100° C. were amorphous however; XRD analysis showed that the presence of Ta and Nb dramatically affected the phase transformation from anatase to rutile. The Ta-doped powders showed the presence of only the anatase phase up to 850° C. and the crystallite size increased only slightly. In [Kim and Lin, 1998] a thermally stable phase structure of zirconia membrane was obtained by doping 8 mol % yttria in zirconia.

Carbides, nitrides, carbonitrides, and borides or combinations thereof can be synthesized from a sol-gel process as in the synthesis of metal oxides. In this process the alkoxide can be substituted with organometallic compounds in which an organic group is directly bonded to a metal without any intermediate oxygen [Pierre, 1998].

Sol-gel chemistry is a new route to synthesize non-oxide ceramics as carbides. Normally carbides are produced by pyrolysis or carbothermal reduction of TiO₂. The sol-gel process can in principle be applied before pyrolysis. The pyrolysis can then produces an amorphous residue, mostly a carbon-oxide composite, which can easily be converted into carbide [Preiss et al., 1998].

TiC is commercially produced primarily by carbothermal reduction of TiO₂ in a temperature range between 1700-2100° C. [Koc and Folmer, 1997]:

TiO₂+C −>TiC+2CO

The reactants in the carbothermal reaction are separate particles resulting in a product containing unreacted carbon and oxides of titanium. The reaction time for the production of TiC from a carbothermal reduction is typically 10-20 hr [Koc and Folmer, 1997] and results in a final product with a low specific surface area [Li et al., 2001].

A conventional chemical vapour deposition (CVD) method is also used to the synthesis of carbides, nitrides, carbonitrides, and borides because of its economical benefit for many ordinary applications without any complicated demands for films and coatings [Andrievski, 1997]:

TiCl₄+1/nCₙHₘ+H₂−>TiC(s)+4HCl+(m/2n−1)H₂

TiCl₄+½N₂+2H₂−>TiN(s)+4HCl

TiCl₄+3BCl₃+5H₂−>TiB₂(s)+10HCl

The three processes are very corrosive due to the present of TiCl₄ and HCl [Koc and Folmer, 1997]. In most cases the temperature interval for synthesis of CVD films is between 900-1100° C. The advantages and different versions of CVD is described in [Andrievski, 1997], wherein other physical and chemical preparation methods also are described.

[Krishnan et al., 1989] describes the production of silicon, titanium, and vanadium carbides by a reaction between the respective metals, a binder, and a carbon source. The metal and carbon particles are mixed and heated to a temperature sufficient to melt the metal and a reaction between the solid carbon and the liquid metal is taken place. The temperature is between 1550-2000° C. depending on the metal (the melting point for titanium is 1668° C. and 1888° C. for vanadium) and the temperature is held for 90 min. The product is porous metal carbide with a particle size of 0.05-10 mm in diameter. [Gallo and Greco, 1992] describe the production of transition metal carbide and boride through a reaction between TTIP, water and a carbon source. The two carbon sources presented in the patent are shown in table 1 together with physical and chemical data:

TABLE 1
Characteristics of Succinic acid and Terephthalic acid.

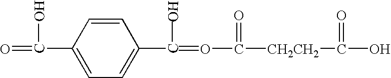

| | Succinic acid | Terephthalic acid |
|---|---|---|
| Synonyms | Butanedioic acid | Benzene-1,4-dicarboxylic acid,p-Benzene Di-carboxylic acid,p-Di-carboxy benzene,p-Phathalic acid |
| Mw | 118.0 g/mol | 166.1 g/mol |
| Solubility in water | 0.28 g/100 ml at 20° C. | Insoluble |

[Ogawa and Fukuda, 1993] describe a process where carbon black is introduced as a third reactant in a normal sol-gel process. The carbon black was suspended in isopropanol by applying ultrasonic irradiation. The metal alkoxide was added to the carbon solution, and then it was hydrolyzed by adding the water-isopropanol mixture. The process scheme is shown on the following flow chart.

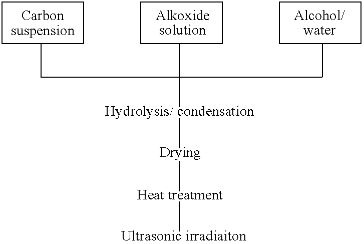

### Production of transition metal carbides [Ogawa and Fukuda, 1993]

For preparing mixtures of ZrC and ZrB₂ [Ogawa and Fukuda, 1993] used triethylborate (CH₂CH₂O)O₃B, which was added to the starting solution. The dried gels from this method are amorphous and to get carbides with small amount of oxygen the powder was heated to 1400° C. for four hours.

[Li et al., 2001] describes the preparation of binary carbonaceous titania aerogel by a sol-gel supercritical fluid drying and its carbothermal reduction conversion into Ti(C, N, O) in argon atmosphere. By this process they produce a homogeneous mixture of carbon and titania particles. The sol-gel process involves the reaction between TiCl₄, distilled water, and a synthesized carbonaceous alcohol. Afterwards the product is supercritical dried at 250° C. and 7.0 MPa resulting in a product consisting of tetragonal TiO₂ and amorphous carbon. Further heat treatment with temperatures from 1000° C.-1300° C. results in formation of a Ti(C, N, O) phase which will grow as a function of temperature. This growth causes a reduction of the specific surface area and the particle size of Ti(C, N, O) increases with the increase of temperature.

[Koc and Folmer, 1997] have developed a method for producing TiC from a carbothermal reduction of carbon coated TiO₂ precursor and TiO₂ mixed with carbon black. The process takes place at temperatures from 1100-1550° C. for two hours in an argon atmosphere. The method described produces uniform submicron TiC particles with a transition temperature for the formation of TiC at 1400° C. The specific surface area increases until 1300° C. (110-170 m²/g) and decreases to ≦30 m²/g at 1500° C. The particle size is 100 nm to 500 nm.

Besides titanium carbide, the above method can also be used to produce titanium nitride and titanium carbonitride [Koc and Glatzmaier, 1995]. Instead of using an argon atmosphere a nitrogen atmosphere is used to produce titanium nitride and titanium carbonitride. The average particle size is found to be 50-200 nm.

Electroceramic materials can be synthesized from several methods, but due to important characteristics for electroceramic applications the sol-gel process has shown promising results.

Normal sol-gel preparation methods of Barium titanate yield crystalline BaTiO₃ at 700° C. with a low surface area down to 11.2 m²/g (Komarneni et al., 1999].

[Paik et al., 1997] describes a sol-gel method for producing BaTiO₃ and (Ba_{0.6}Sr_{0.4})TiO₃ thin films using inexpensive Ba/Sr hydroxides which were reacted with Titanium butoxide. The resulting material was annealed at temperatures between 600-800° C.

[Rao et al., 1998] has prepared LiNbO₃ by a sol-gel method. Initially a LiNbO₃ precursor is synthesized from lithium 2,4-pentanedionate and 2-methoxyethanol and niobium ethoxide and 2-methoxyethanol. These two solutions were then refluxed at 125° C. for 12 hours in an argon atmosphere. The produced lithium niobate precursor was then hydrolyzed with water and the resulting gel was heat treated at 500° C.

[Wu et al., 1997] have produced PZT from a sol-gel process using lead acetate, titanium isopropoxide or titanium diisopropoxide bis(2,4-pentanedionate), and zirconium propoxide as starting materials diluted in acetone and fine PZT(52/48) powders were used as seeds. They found that the perovskite phase was obtained from 450-600° C. depending on modification of the precursors and amount of seeds.

[Poosanaas et al., 1997] have studied ceramics of PLZT doped with WO₃ and Nb₂O₅. The PLZT was prepared by the sol-gel process from lead(II) acetate trihydrate, lanthanum(III) acetylacetone hydrate, Zr, Ti, Nb, and W alkoxides. PLZT (3/52/48) with a 3% La and a Zr/Ti ratio of 52/48 was found to give the highest photovoltaic effect. The resulting gels were calcined at temperatures up to 1270° C. It was shown in this paper that the grain size decreases with increasing doping concentration. The dielectric and piezoelectric properties were found to decrease with increasing doping concentration due to the smaller grain size.

[Beltrán et al., 2003] prepared compositions based on PbO—MgO—Nb₂O₅ by a sol-gel process from a multicomponent alkoxide solution at room temperature. The alkoxide solution was prepared from mixing lead acetate, anhydrous magnesium acetate, and niobium ethoxide with acetylacetone as solvent. The resulting gel was calcined at 800° C.

### Applications

As the above prior art suggests, sub-micron and nanoparticles, amorphous and crystalline, have received tremendous interest in recent years. This interest is spurred by the observation that many properties of materials are radically altered with the inclusion of various forms of nanoparticles. Owing to the small volumes and the large surface-to-volume ratio, both electronic and physical characteristics of the materials can be strongly affected. For some characteristics it is important that the nanoparticle is amorphous, for others, that it has a certain crystalline phase.

An incomplete list of applications, in which metal-oxide nanoparticles can yield significant performance improvements is: Chemical-mechanical polishing, Electroconductive coatings, Magnetic Fluid Seals, Magnetic recording media, multilayer ceramic capacitors, optical fibres, phosphors, quantum optical devices, solar cell, antimicrobials, biodetection, biomagnetic separations, MRI contrast agents, orthopedics, sunscreens, automotive catalysts, ceramic membranes, fuel cells, photo catalyst, propellants, scratch-resistant coatings, structural ceramics and thermal spray coatings.

TiO₂ in the anatase phase is well known for photoelectrical, photocatalytic, and optical applications and has been used as oxygen and polluting gas sensors. Titania is used as gas sensors because solid state gas sensors will be dramatically cheaper than analytical equipment. The gas sensors can be used to monitor atmospheric pollutants [Traversa et al., 2001].

One of the main factors enhancing the detection properties of semiconducting oxides is the grain size and phase transformation. The sensitivity is expected to increase as the grain size decreases under the space charge depth. To achieve this doped titania are used as gas sensors [Traversa et al., 2001].

Other applications where doped oxides are used is in membrane technology in which alumina, titania, and zirconia membranes are the three most common porous membranes prepared by the sol-gel method. However, for the use of zirconia membranes at higher temperature (>400° C.) doping is necessary. This is because zirconia membranes normally are in the metastable tetragonal phase and at higher temperatures it transform to stable monoclinic phase [Kim and Lin, 1998].

A thermally stable phase structure of zirconia membrane can however, be obtained by doping 8 mol % yttria in zirconia. The yttria stabilized zirconia can be used as the electrolyte for solid oxide fuel cells, oxygen sensors, and oxygen pumps [Kim and Lin, 1998].

Metal carbides, nitrides, and carbonitrides are the leading advanced engineering ceramics used in metalworking, electrical and electronic, automotive, and refractory industries [Koc and Folmer, 1997]. TiN films are a particular leader both in applications and publications [Andrievski, 1997].

Metal carbides are important because they have very high melting points, show considerable resistance to chemical attack, and are extremely hard. The most important of these compounds is tungsten carbide, WC, of which 20,000 tones is produced annually worldwide. Most of the material is used in cutting tools [Rayner-Canham and Overton, 2003].

Titanium carbide (TiC) ceramics are expected to be applied in many high technological fields such as mechanical, chemical, and electronic. Titanium carbide has several properties such as a high meting point, high hardness, high chemical and thermal stability, high wear resistance, and high solvency for other carbides, which make it a promising material in many high field technologies such as mechanical, chemical, and electronics [Li et al., 2001]. TiC combines the advantages of high melting point (3260° C.) and hardness (Knoop's=32.4 GPa) with low density (4.93 g/ml) and shows high resistance to both oxidation and corrosion [Koc and Folmer, 1997]. TiC is used as substitute for tungsten carbide (WC) due to similar properties, and nickel is often used as a binder in TiC, whereas cobalt is used in WC.

The properties of metal carbides, nitrides, carbonitrides, and borides influence the application in where the materials can be used. Especially the impurities and grain sizes have great influence on the quality of the synthesized material. The hardness of nanostructures increased as the particle size or grain size decreases. For example the hardness of a TiN film increases 63% going from a crystallite size of 50 nm to 20 nm [Andrievski, 1997]. It is also seen for high quality nanocrystalline samples of copper that the hardness increases with decreasing grain size at least down to a grain size of 10-15 nm. However, simulations show that there is a maximum in hardness and below 10-15 nm the hardness seems to decrease as a function of decreasing grain size [Schiøtz and Vegge, 1999].

Purity, particle size, and homogeneity are also the most important characteristics of electroceramic powders which determine the electrical properties such as dielectric loss, dielectric constant, and curie temperature of the sintered ceramics [Komarneni et al., 1999].

Purity of the derived powders can be controlled by the purity of the starting chemicals, homogeneity can be controlled by precisely controlling the hydrolysis, condensation, and polymerization reaction [Komarneni et al., 1999].

The preparation of some important electroceramic materials: BaTiO₃, MgTiO₃, PbTiO₃, Bi₄Ti₃O₁₂, LaTi₂O₇, Pb(Zr_{0.52}Ti_{0.48})O₃ [PZT], Pb(Mg_{1/3}Nb_{2/3})O₃ [PMN], and Ba(Mg_{1/3}Ta_{2/3})O₃ [BMT], PLZT, and LiNbO₃ has been prepared by sol-gel processes with a post heat treatment to obtain a crystalline products [Komarneni et al., 1999], [Poosanaas et al., 1997], [Rao et al., 1998].

Of the listed electroceramics barium titanate, BaTiO₃, is the most widely used material in capacitor industry. Therefore is it convenient to find a cost-effective preparation method [Komarneni et al., 1999]. BaTiO₃ thin films are highly suitable for several useful device applications such as multi layer hybrid capacitors, pyroelectric detectors, thermistors, because of its relatively large dielectric constant and good ferroelectric properties [Paik et al., 1997].

Next to BaTiO₃ PZT is the most widely used electroceramic material [Komarneni et al., 1999]. Ferroelectric thin films of lead zirconate titanate (PZT) are of actual technological interest for use as components for non-volatile memories, electro-optic devices, pyroelectric sensors, and piezoelectric transducers. For all these devices the fundamental requirement is the high quality pure perovskite phase films with optimized grain size, crystallographic orientation and thickness. The sol-gel process has shown to be promising for this purpose but the perovskite phase of the lead based family of materials is formed at higher temperature which normally involves a post-deposition thermal treatment. Typical temperatures for the formation of PZT perovskite phase vary between 650 and 750° C. The thermal treatment causes thermal stresses and effects the long term reliability [Wu et al., 1997].

Lanthanum modified lead zirconate titanate (PLZT) ceramics are also of interest due to its high optical transparency, desirable electrooptic properties and fast response [Poosanaas et al., 1997].

The ferroelectric lead magnesium niobate, Pb(Mg_{1/3}Nb_{2/3})O₃, (PMN) has a broad maximum dielectric constant just below room temperature and is a potential alternative to BaTiO₃ in multilayer ceramic capacitors and electrostrictive actuators [Komarneni et al., 1999]. However, PMN is difficult to prepare in the perovskite from without the appearance of pyrochlore phases. The sol-gel method has been used to prepare single phase PMN. The sol-gel process offers numerous potential advantages for PMN formation compared to solid state routes [Beltrán et al., 2003].

Litium niobate powder, LiNbO₃, has a large non-linear optical coefficient, a large birefringence, a high electro-optic coefficient, a high Curie temperature, good piezoelectric and excellent acousto-optic properties which makes it applicable for optical wave guides, optical modulators, optical switches, and sound acoustic wave (SAW) devices [Rao et al., 1998]. Sol-gel processing is a promising technique for producing LiNbO₃ because it gives precise control over stoichiometry and low reaction temperature. The precursors for preparation of LiNbO₃ could be lithium alkoxide or lithium acetate as lithium source [Rao et al., 1998].

Integration of nanoparticles in a broad range of applications listed in the above text is already taking place at the industrial scale. However, for many applications the cost of nanoparticles is prohibitive, severely limiting the number of applications which can benefit. The general trend is for prices to rise as the size of the nanoparticles becomes smaller. Unfortunately it is also a general trend, that it is the smaller nanoparticles that yield the largest improvement in performance.

The cost of high quality (purity, specific surface area, spherical) is also a great hinder in the wide commercialization of carbides, nitrides, carbonitrides, and borides. The syntheses of high quality TiC powders require expensive steps that yield only small quantities of product [Koc and Folmer, 1997]. In the following table is shown some price examples for commercial available carbides and carbonitrides.

TABLE 2
Prices on commercially available carbides and carbonitrides
[Nanostructured and Amorphous Material, 2003].

| | Price [$/kg] | |
|---|---|---|
| | by buying 1 kg | Characteristics |
| TiC, 80 nm | 495 | 25-45 m²/g, black, 98% purity, spherical |
| TiC, 130 nm | 450 | 25-45 m²/g, black, 98% purity, spherical |
| Ti(C_{0.7}N_{0.3}) | 495 | 97+%, 80 nm |
| Ti(C_{0.5}N_{0.5}) | 495 | 97+%, 80 nm |
| SiC, | 530 | 10 · 100 nm, 121-145 m²/g, 97.8% purity |
| amorphous | | |
| SiC, beta | 1375 | 20 nm, 94 m²/g, 97% purity, nearly |
| | | spherically |

### SUMMARY OF THE INVENTION

It may be an object of the invention to produce metal oxides, metaloxy hydroxides, metal hydroxides, metal carbides, metal nitrides, metal carbonitrides, metal borides, electroceramics and other substances/materials in the form of sub-micron or nanoparticles, by a method in which the total energy budget is minimised, thereby reducing appreciably the cost of the final product. Said substances may be an intermediate substance for further processing to other substances or materials or products.

It may be an object of the invention to produce semi-metal oxides, semi-metaloxy hydroxides, semi-metal hydroxides, semi-metal carbides, semi-metal nitrides, semi-metal carbonitrides, semi-metal borides, electroceramics and other substances/materials in the form of sub-micron or nanoparticles, by a method in which the total energy budget is minimised, thereby reducing appreciably the cost of the final product. Said substances may be an intermediate substance for further processing to other substances or materials or products.

It may furthermore be an object of the invention to produce metal compounds such as metal oxides, metaloxy hydroxides, metal hydroxides, metal carbides, metal nitrides, metal carbonitrides, metal borides, electroceramics and other substances/materials in the form of sub-micron or nanoparticles, by a method capable of inexpensively yielding very small nanoparticles that normally have a particular high price.

It may furthermore be an object of the invention to produce semi-metal compounds such as semi-metal oxides, semi-metaloxy hydroxides, semi-metal hydroxides, semi-metal carbides, semi-metal nitrides, semi-metal carbonitrides, semi-metal borides, electroceramics and other substances/materials in the form of sub-micron or nanoparticles, by a method capable of inexpensively yielding very small nanoparticles that normally have a particular high price.

It may also be an object of the invention to produce metal compounds such as metal oxides, metaloxy hydroxides metal hydroxides, metal carbides, metal nitrides, metal carbonitrides, metal borides, electroceramics and other substances/materials in the form of sub-micron or nanoparticles, in which particle size, crystal phase, and degree of crystallinity can be controlled by external parameters without having to resort to costly post-reaction processing.

It may also be an object of the invention to produce semi-metal compounds such as semi-metal oxides, semi-metaloxy hydroxides, semi-metal hydroxides, semi-metal carbides, semi-metal nitrides, semi-metal carbonitrides, semi-metal borides, electroceramics and other substances/materials in the form of sub-micron or nanoparticles, in which particle size, crystal phase, and degree of crystallinity can be controlled by external parameters without having to resort to costly post-reaction processing.

It may also be an object of the invention to produce metal compounds such as metal oxides, metaloxy hydroxides metal hydroxides, metal carbides, metal nitrides, metal carbonitrides, metal borides, electroceramics and other substances/materials in the form of sub-micron or nanoparticles, in which small amounts of other elements have been added in order to alter, controlling and/or improve the nanoparticle characteristics and nanostructure such as homogeneity, grain size, thermal stability, surface defects, and phase structure stabilization.

It may also be an object of the invention to produce metal compounds such as semi-metal oxides, semi-metaloxy hydroxides, semi-metal hydroxides, semi-metal carbides, semi-metal nitrides, semi-metal carbonitrides, semi-metal borides, electroceramics and other substances/materials in the form of sub-micron or nanoparticles, in which small amounts of other elements have been added in order to alter, controlling and/or improve the nanoparticle characteristics and nanostructure such as homogeneity, grain size, thermal stability, surface defects, and phase structure stabilization.

In a first aspect, one or more of these and possible other objects are achieved by a method of manufacturing a metal compound such as metal oxides, metaloxy hydroxides metal hydroxides, metal carbides, metal nitrides, metal carbonitrides, metal borides, electroceramics and other such compound said compound having a sub-micron primary particle size, comprising the steps of:
introducing a solid reactor filling material in a reactor,
introducing a metal-containing precursor in said reactor,
introducing a reactant into said reactor
introducing a supercritical solvent into the said reactor,
establishing a contact between the metal-containing precursor and the reactant, thus
resulting in the formation of said product in the proximity of the said solid reactor filling material.

In an altered first aspect, one or more of these and possible other objects are achieved by a method of manufacturing a semi-metal compound such as semi-metal oxides, semi-metaloxy hydroxides, semi-metal hydroxides, semi-metal carbides, semi-metal nitrides, semi-metal carbonitrides, semi-metal borides, electroceramics and other substances/materials said product having a sub-micron primary particle size, comprising the steps of:
introducing a solid reactor filling material in a reactor,
introducing a semi-metal-containing precursor in said reactor,
introducing a reactant into said reactor
introducing a supercritical solvent into the said reactor,
establishing a contact between the semi-metal-containing precursor and the reactant, thus
resulting in the formation of said product in the proximity of the said solid reactor filling material.

Possibly, the reactant comprises an initiator or the like for initiating the process. Alternatively or additionally, the reactant comprises a co-solvent as cleaning agent.

In a second aspect, one or more of these and possible other objects are achieved by a method of manufacturing a metal compounds such as metal oxides, metaloxy hydroxides metal hydroxides, metal carbides, metal nitrides, metal carbonitrides, metal borides, electroceramics and other substances/materials said product having a sub-micron primary particle size, comprising the steps of:
introducing a solid reactor filling material in a reactor,
introducing a metal oxide in said reactor,
introducing a substitution source into said reactor,
introducing a supercritical solvent into the said reactor,
establishing a contact between the metal oxide and the substitution source, thus
resulting in the formation of said product in the proximity of the said solid reactor filling material.

In an altered second aspect, one or more of these and possible other objects are achieved by a method of manufacturing a semi-metal compounds such as semi-metal oxides, semi-metaloxy hydroxides, semi-metal hydroxides, semi-metal carbides, semi-metal nitrides, semi-metal carbonitrides, semi-metal borides, electroceramics and other substances/materials said product having a sub-micron primary particle size, comprising the steps of:
introducing a solid reactor filling material in a reactor,
introducing a semi-metal oxide in said reactor,
introducing a substitution source into said reactor
introducing a supercritical solvent into the said reactor,
establishing a contact between the semi-metal oxide and the substitution source, thus
resulting in the formation of said product in the proximity of the said solid reactor filling material.

Possible compounds manufactured by the method according to any of the above-mentioned aspects of the invention may be selected from the group of metal oxides such as: titanium oxide, zinc oxide, copper oxide, aluminium oxide, vanadium oxide, magnesium oxide, zirconium oxide, chromium oxide, silicon oxide, molybdenum oxide, niobium oxide, tungsten oxide, hafnium oxide, tantalum oxide and iron oxide.

The compounds may also be selected from the group of metal carbides such as: titanium carbide, zinc carbide, copper carbide, aluminium carbide, vanadium carbide, magnesium carbide, zirconium carbide, chromium carbide, silicon carbide, molybdenum carbide, niobium carbide, tungsten carbide, hafnium carbide, tantalum carbide, cobalt carbide, manganese carbide, nickel carbide, berylium carbide and iron carbide.

The compounds may also be selected from the group of metal nitrides such as: titanium nitride, zinc nitride, copper nitride, aluminium nitride, vanadium nitride, magnesium nitride, zirconium nitride, chromium nitride, silicon nitride, molybdenum nitride, niobium nitride, tungsten nitride, hafnium nitride, tantalum nitride, cobalt nitride, manganese nitride, nickel nitride, berylium nitride and iron nitride.

The compounds may also be selected from the group of metal carbonitrides such as: titanium carbonitride, zinc carbonitride, copper carbonitride, aluminium carbonitride, vanadium carbonitride, magnesium carbonitride, zirconium carbonitride, chromium carbonitride, silicon carbonitride, molybdenum carbonitride, niobium carbonitride, tungsten carbonitride, hafnium carbonitride, tantalum carbonitride, cobalt carbonitride, manganese carbonitride, nickel carbonitride, berylium carbonitride and iron carbonitride.

The compounds may also be selected from the group of metal borides such as: titanium boride, zinc boride, copper boride, aluminium boride, vanadium boride, magnesium boride, zirconium boride, chromium boride, silicon boride, molybdenum boride, niobium boride, tungsten boride, hafnium boride, tantalum boride, cobalt boride, manganese boride, nickel boride, berylium boride and iron boride.

Which of the methods that is chosen according to the different aspects of the invention depends on the process most suitable for the production of the compound in question and depends on the desired physical, electrical, chemical and other properties of the compound produced.

Electroceramics comprises ceramics form the group of: Ferroelectrics, Ferrites, Solid Electrolytes, Piezoelectrics-sonar and Semiconducting Oxides. The performance of electroceramic materials and devices depends on the complex interplay between processing, chemistry, structure at many levels and device physics and so requires a truly interdisciplinary effort by individuals from many fields. Topical areas cover a wide spectrum with recent active areas including sensors and actuators, electronic packaging, photonics, solid state ionics, defect and grain boundary engineering, magnetic recording, nonvolatile ferroelectric memories, wide band gap semiconductors, high T_{c} superconductors, integrated dielectrics and nano-technology.

Possibly, the process comprises a step of introducing a co-solvent into the said reactor,

In the case of the product being metal carbides, metal nitrides, metal carbonitrides, and metal borides the method could require the introduction of a substitution source comprising at least one of the following components: carbon, nitrogen, boron and/or any combination of these.

Additionally metal carbides, metal nitrides, metal carbonitrides, and metal borides could be produced by introducing a metal oxide and a substitution source comprising at least one of the following components: carbon, nitrogen, boron and/or a combination of these in the method.

In the context of the present application, the primary particles are the nano- or at least sub-micron particles that result from the formation. Usually these primary particles are relative weakly bounded together in aggregates of particles. These aggregates can be considered as secondary particles. The scale of said proximity can be any scale ranging from an atomic level, a nano level, a micron level up to a macroscopic level.

Preferably, the formation takes place by a process involving a sol-gel reaction. The product obtained may either be substantially crystalline and substantially amorphous. In general, it may also be a combination of several different phases.

Alternatively, the formation takes place by a process involving a substitution process. The product obtained may either be substantially crystalline and substantially amorphous. In general, it may also be a combination of several different phases. Said substances may be an intermediate substance for further processing to other substances or materials or products.

The method can be applied such that the introduction of the solid reactor filling material, the metal-containing precursor or the semi-metal-containing oxide, alternatively the semi-metal-containing precursor or the semi-metal-containing oxide, the reactant, alternatively the substitution source, the possible co-solvent, and the supercritical solvent into the said reactor may be done in any arbitrary order for easy and fast manufacturing.

Additionally, one of the components: the solid reactor filling material, the metal-containing precursor or the metal-containing oxide, alternatively the semi-metal-containing precursor or the semi-metal-containing oxide, the reactant, alternatively the substitution source, the possible co-solvent or the supercritical solvent, may be mixed with any of the other components before introduction into the reactor. Furthermore, the method may be applied in a mode selected from the group of: batch mode, quasi-batch mode and continuos mode. This will be further elaborated in the detailed description.

The temperature in the reactor during the formation of said product is possibly kept at a fixed temperature, but may also be performed at an increasing or a decreasing temperature, preferably with respect for the supercritical conditions to be fulfilled. Even alternatively, the temperature in the reactor may have a temperature profile consisting in an arbitrary selection of one or more fixed temperatures, one or more increasing temperatures and one or more decreasing temperature.

The temperature in the reactor during the formation of the product is possibly maximum 800° C., or maximum 700° C., or maximum 600° C., or maximum 500° C., or maximum 400° C., or maximum 300° C., or maximum 200° C., or maximum 100° C., and even possibly maximum 50° C.

The pressure in the reactor during the formation of said product is possibly kept at a fixed pressure, but may also be performed at an increasing or decreasing pressure, preferably, with respect for the supercritical conditions to be fulfilled. Even alternatively, the pressure in the reactor may have a pressure profile consisting in an arbitrary selection of one or more fixed pressures, one or more increasing pressures and one or more decreasing pressures.

Using carbon dioxide as supercritical solvent, the pressure in the reactor during the formation of the product should be as minimum 74 bar and the temperature in the reactor a minimum of 31° C. If using isopropanol as supercritical solvent, the pressure in the reactor during the formation of the product should be as minimum 47 bar and the temperature in the reactor a minimum of 235° C.

The supercritical solvent may be supercritical before the introduction into the reactor or brought into a supercritical phase after the introduction into the reactor.

The supercritical fluid may be an alcohol or may contain an alcohol. It is especially preferred that the alcohol is the same as that which is part of the sol-gel reaction. In certain cases it may be preferable to control the alcohol concentration and the water concentration during the reaction with the intention of controlling the particle formation process and the resulting characteristics such as particle size and crystallinity. The particle may be controlled by for example controlling the addition of the supercritical media or in a continuous system controlling the flow rate, or indeed controlling the temperature, and/or pressure thereby controlling the concentration. In a preferred embodiment these parameters are controlled during the reaction in a predefined manner e.g. by withdrawing at least part of the time at least part of said fluid from the reaction vessel to an external recirculation loop, wherein these parameters are controlled. The fluid being recycled to the reaction vessel after conditioning.

As an example, the present invention offers, by means of a dedicated selection of the above process parameters, the astonishing possibility of producing anatase phase of TiO₂ already at temperatures as low as between 50° C. and 100° C. and at concurrent pressures of 100-200 bar.

The time of the formation of the product span the gap from maximum 0.5 hour to maximum 24 hours, depending on the number of process parameters, the number of process components and the one or more products for being produced by the process.

Preferably, a plurality of different metal-containing precursors, alternatively semi-metal-containing precursors, may be introduced into the reactor opening to a wider variety of alloy-products being formed and also opening to possible doping of the product.

The metal-containing precursor may for example be a metal alkoxide, such as titanium tetraisopropoxide, titanium butoxide, titanium ethoxide, titanium methoxide, aluminium isopropoxide, aluminium-sec-butoxide, magnesium ethoxide, or Ta, Ba, Sr, Li, Nb, Pb, W, La alkoxides.

The metal-containing precursor may for example be a metal acetate, such as Ti, Al, Mg, Ta, Ba, Sr, Li, Nb, Pb, W, La acetates.

The metal-containing precursor may be a metal salt, such as Ti(SO₄)₂, TiCl₄ or AlCl₃. In certain caus of metal salt precursors it may be advantageous to use suitable co-solvents and/or surfactants. In such instances the fluid containing the metal containing precursor dissolved or dispersed therein further comprises one or more surfactants, said surfactants being preferably selected from the group consisting of hydrocarbons and fluorocarbons preferably having a hydrophilic/lipophilic balance value of less than 15, where the HLB value is determined according to the following formula: HLB=7+sum(hydrophilic group numbers)−sum(lipophilic group numbers).

Preferably, the reactant is selected from the group of: water, ethanol, methanol, hydrogenperoxid and isopropanol. Other reactants may additionally or alternatively be introduced in the reactor.

Preferably, the co-solvent may be selected from the group of: water, ethanol, methanol, hydrogenperoxid and isopropanol. Other co-solvents may additionally or alternatively be introduced in the reactor.

The solid reactor filling material may function as a heterogeneous catalyst, preferably with a promoter. The solid reactor filling material may have various different forms, such as one or several fibres, a powder, and a substantially porous structure.

The solid reactor filling material may also have a size and shape capable of substantially confining the metal-containing precursor to a limited part of the reactor. For example in form of a wad of fibres in top of the reactor confining the precursor to the top of the reactor, thereby separating the metal-containing precursor from the rest of the reactor, e.g. a liquid in the bottom of the reactor. Alternatively, the solid reactor filling material has the shape from the group of a sponge, a grid, and a sheet.

The solid reactor filling material may comprise a polymer, such as polystyrene (PS), polypropylene (PP), polyethylene (PE), polyvinyl chloride (PVC), polyvinylidene chloride (PVDC), or polyvinyl acetate (PVAc).

Alternatively, the polymer is from the group of: acrylic polymer, fluorinated polymer, diene polymer, vinyl copolymer, polyamide polymer, polyester polymer, polyether polymer, or polyimide polymer.

The solid reactor filling material may also comprise a metal, such as titanium, aluminium, zinc, vanadium, magnesium, zirconium, chromium, molybdenum, niobium, tungsten, copper, or iron.

The solid reactor filling material may comprise a metal oxide, such as titanium oxide, zinc oxide, copper oxide, aluminium oxide, vanadium oxide, magnesium oxide, zirconium oxide, chromium oxide, molybdenum oxide, niobium oxide, tungsten oxide, or iron oxide. The solid reactor filling material may alternatively comprise a semi-metal oxide such as silicon oxide or boron oxide.

Possibly, the solid reactor filling material may comprise a ceramic, either natural or artificial. Possibly, the solid reactor filling material comprises a metal sulphate or a metal halide.

The solid reactor filling material may function as seed material for the formation of the product. Possibly, the solid reactor filling material comprises a metal oxide, metal oxidhydroxide or metal hydroxide. Alternatively, the solid reactor filling material comprises a semi-metal oxide, a semi-metal oxidhydroxide or a semi-metal hydroxide. In case of the solid reactor filling material functioning as a seed material, the material is thus identical to the product resulting from the formation in the reactor in order to initiate the formation of the product. The formation may for example also be by precipitation, catalysis, or growth. Alternatively, the solid reactor filling material functions as a collecting agent for the product.

The product is preferably separable from the solid reactor filling material with no further treatments of the solid reactor filling material. In this manner, the solid reactor filling material substantially does not degrade. Preferably, this allows the solid reactor filling material to be re-used as solid reactor filling material in a new formation step. The separation from the solid reactor filling material may take place by flushing the solid reactor filling material in a fluid, by jolting, by vacuum means, by blowing means, or by ultrasonic means.

In comparison with known solutions within the prior art, e.g., exploiting nanostructured templates, the present invention is characterised by the fact that the sub-micron product is readily separable from the reactor filling material without the need for plasma treatments, calcination or further chemical processing of the reactor filling material. Using e.g. nanostructured templates causes the product to be embedded within the template, which necessitates a separation step that degrades the template. This is not the case with the present invention.

In an aspect of the invention, the invention relates to a metal oxide, metal oxidhydroxide or metal hydroxide product, a semi-metal oxide, semi-metal oxidhydroxide or semi-metal hydroxide product manufactured by the method of one of the aspects of the invention, wherein the product is in the form of aggregates of primary particles with an average primary particle size of in the range of 10-1000 nm.

In the presently most preferred embodiment the metal oxide product manufacturing by the method is TiO₂, preferably with a crystallinity of minimum 20%, preferably minimum 30%, more preferably minimum 40%, and even more preferably minimum 60% and even most preferably minimum 80%. The titanium dioxide can be substantially crystalline anatase.

Alternatively, the metal oxide is from the group of: Al₂O₃, TiO₂, ZrO₂, Y₂O₃, WO₃, Nb₂O₅, TaO₃, CuO, CoO, NiO, SiO₂, Fe₂O₃ or ZnO. Other materials to be produced comprises carbides from the group of: TiC, ZrC, NbC, WC, TaC, VC, MoC, SiC, CoC, HfC, CrC, MnC, NiC, FeC, Be2C,BC; nitrides from the group of: TiN, ZrN, NbN, CrN, HfN, AlN, Si3N4, GaN, BN; cabonnitrides from the group of: Ti(C_{0.7}N_{0.3}), Ti(C_{0.5}N_{0.5}), TiCₓN_{y}; borides from the group of: ZrB₂, TiB₂, or any combination thereof such as TiBN_{0.5}, TiB₂N. Even rare earth compounds such as e.g. Pr203, Sm203, Gd203 and Dy203 may be produced by a method according to any of the aspects of the invention.

More alternatively, the metal oxidhydroxide is from the group of: iron oxidhydroxide, titanium oxidehydroxide, manganese oxidhydroxide or aluminium oxidhydroxide.

Most alternatively, the metal hydroxide is from the group of: iron hydroxide, silicon hydroxide, zirconium hydroxide, titanium hydroxide, manganese hydroxide or aluminium hydroxide.

An aspect of the invention concerns an apparatus for manufacturing a metal compound such as metal oxides, metaloxy hydroxides, metal hydroxides, metal carbides, metal nitrides, metal carbonitrides, metal borides, electroceramics and other such compound, said compound having a sub-micron primary particle size, comprising the following components:
means for introducing a solid reactor filling material in a reactor,
means for introducing a metal-containing precursor in said reactor,
either means for introducing a reactant in said reactor
or means for introducing a substitution source in the said reactor
means for introducing a supercritical solvent into the said reactor,
said reactor intended as a space for establishing a contact between the metal-containing precursor and the reactant, or between the metal-containing precursor and the substitution source and
said reactor intended as a space for the formation of said compound in the proximity of the said solid reactor filling material.

As an alternative aspect of the invention concerns an apparatus for manufacturing a semi-metal compound such as semi-metal oxides, semi-metaloxy hydroxides, semi-metal hydroxides, semi-metal carbides, semi-metal nitrides, semi-metal carbonitrides, semi-metal borides, semi-electroceramics and other such compound, said compound having a sub-micron primary particle size, comprising the following components:
means for introducing a solid reactor filling material in a reactor,
means for introducing a semi-metal-containing precursor in said reactor,
either means for introducing a reactant in said reactor
or means for introducing a substitution source in the said reactor
means for introducing a supercritical solvent into the said reactor,
said reactor intended as a space for establishing a contact between the semi-metal-containing precursor and the reactant, or between the semi-metal-containing precursor and the substitution source and
said reactor intended as a space for the formation of said compound in the proximity of the said solid reactor filling material.

For the production of metal carbides, metal nitrides, metal carbonitrides, and metal borides the invention requires introducing a carbon, nitride, carbonitride, or boride source. The substitution sources may be introduced separately or by the precursor.

The process could alternatively include a metal oxide and a substitution source in a fiber filled reactor. The supercritical CO₂ is then introduced in the reactor and a carbothermal reduction of for example the TiO₂ is takes place.

The processes are carried out at low reaction temperature, which makes it possible to produce a crystalline nanosized material with a small particle size and a high surface area. Normal described methods use high temperatures which causes a grain growth [Andrievski, 2003].

The general schemes for the present invention are shown in the following flow chart.

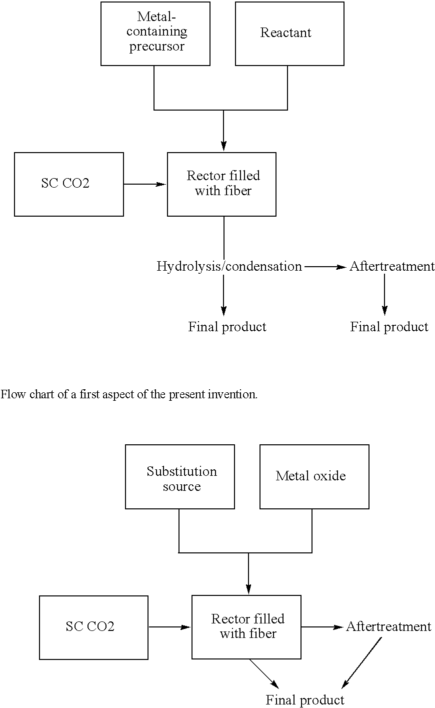

### Flow chart of a second aspect of the present invention.

The process shown in the flow chart of the first aspect of the invention can be carried out as shown in the flow chart or by introducing the incoming material streams in SC CO₂.

The substitution source could be any sources of carbon, nitride, carbonitride, or borides and mixtures of them. The carbon, nitride, carbonitride, and boride sources may also be placed together with the water, the precursor, or alone in a different place in the fiber.

The substitution source could also be any metal or metalloid for doping of the material. The substitute metals could be iron, copper, cobalt, zinc, molybdenum, sodium, lithium, potassium, tantalum, niobium, yttrium or a combination of the different metals. The doping material may also be placed together with the water, the precursor, or alone in a different place in the fiber.

The substitution source could also be any metal oxides or metalloid oxides for doping of the material. The substitute metal oxides and metalloid oxides could be HfO₂, SiO₂, Y₂O₃, ZrO₂, GeO₂, Nb₂O₃, Ta₂O₃, PbO, titanium oxide, zinc oxide, copper oxide, aluminium oxide, vanadium oxide, magnesium oxide, zirconium oxide, chromium oxide, silicon oxide, molybdenum oxide, niobium oxide, tungsten oxide, and iron oxide.

The reactant may consists of just water, a mixture of water and the carbon, nitride, carbonitride, or boride source, a mixture of water and a substitution metal, or a combination of all three constituents.

The metal containing precursor solution may consist of just a single precursor material or a mixture of more materials also including substitution metals as iron, cobalt etc. and carbide, nitride, carbonitride, and boride sources. The metal containing precursor may be an alkoxide for example TTIP.

The metal containing precursor may involve an organometallic compound in which an organic group is directly bonded to a metal without any intermediate oxygen. Precursors could be for example: TDMAT, TMT, Ti(N(CH₃)₂)₄), TDEAT, TET

The metal containing precursor is the metal donor, where the metal may be: titanium, vanadium, silicon, tungsten, zirconium, Al, Ba, Li, Nb, Mg, Pb, Pt, Si, Sr, Ta, Hf, Y, La, Mo or a combination of the different precursors. The metal containing precursor may be introduced as metal acetates.

### BRIEF DESCRIPTION OF THE FIGURES

The invention is hereafter described with reference to the following figures where

FIG. 1 is a schematic illustration of the traditional sol-gel process where the particle size is a function of the reaction time after [Soloviev, 2000],

FIG. 2 is a schematic drawing showing the generalized facility used in the supercritical sol-gel process according to the invention,

FIG. 3 shows the crystalline phases of TiO₂, respectively brookite, anatase and rutile, as a function of crystal phase formation temperature,

FIG. 4 is a combined x-ray diffraction spectrum of the produced anatase TiO₂ powder and the expected location of anatase diffraction peaks,

FIG. 5 shows the density of CO₂, having a low density at normal conditions, as a function of reduced pressure,

FIG. 6 is an x-ray diffraction spectrum of a 50/50 weight ratio TiO₂ and CaF2 used to determine the crystallinity of the titanium dioxide powder as well as the crystallite size,

FIG. 7 is a small-angle x-ray spectrum of an Al₂O₃ product produced by the present invention, used to determine the size of the primary particles,

FIG. 8 is an x-ray diffraction spectrum of a 50/50 weight ratio TiO₂ (as produced by the present invention) and CaF₂ used to determine the crystallinity of the titanium dioxide powder as well as the crystallite size,

FIG. 9 is an x-ray diffraction spectrum of Al₂O₃ product produced according to the present invention showing clear diffraction peaks from the crystal structure termed Boehmite.

### DETAILED DESCRIPTION OF THE INVENTION

The invention, resulting in the production of nano-sized metal oxides, metaloxy hydroxides, or metal hydroxides, preferably makes use of a sol-gel process, in which a precursor of a metal alkoxide or a metal salt is used. In the case of producing TiO₂ a precursor of a metal alkoxide may be e.g. titanium tetraisopropoxide, Ti(OPrⁱ)₄, titaniumbutoxide, Ti(OBu)₄, titaniumethoxide, Ti(OEt)₄, titaniummethoxide Ti(OMe)₄, or precursor of a metal salts may be e.g. TiCl₄, Ti(SO₄)₂.

The sol-gel process starts with the hydrolysis of the precursor, when it comes into contact with water. The hydrolysis continues simultaneously with the condensation of the hydrolyzed monomers leading to formation of nano-sized particles. The overall process can generally be expressed as follows [Livage et al., 1988]:

M(OR)ₙ+½nH₂O→MO_{1/2n}+nROH

As an example, the total hydrolysis/condensation reaction can for the case of TiO₂ formation be expressed as

Ti(OR)₄+2H₂O→TiO₂+4ROH

The process must be controlled to obtain a desired structure and size of the final product. The colloid solution starts out as a sol. If the sol is stable, the solution will remain unchanged. Often, however, a gelation or precipitation of particulate material takes place. Regardless of whether a sol, a gel, or a precipitate is formed, the product will, in the traditional sol-gel process, be dried and often calcined to obtain the final product.

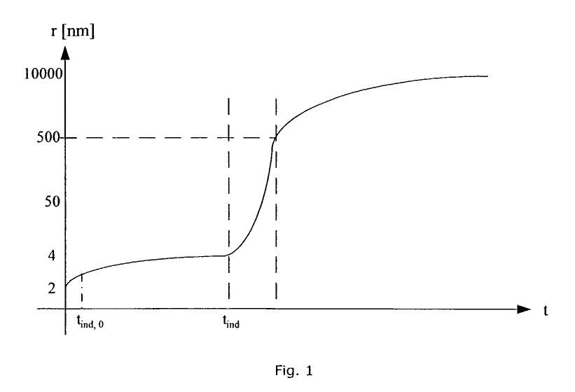

A schematic illustration of the development of the particle size as a function of the reaction time can be seen in FIG. 1. It is seen that in the traditional sol-gel process a final particle size of 1-10 μm is obtained [Soloviev, 2000].

Utilizing a supercritical solvent (e.g. CO₂) can arrest the process shown in FIG. 1. The supercritical solvent makes it possible to control and stabilize the particles such that the particle growth is arrested before the steep part of the curve (in FIG. 1) is reached, consequently resulting in nano-sized particles. By producing the particles in a supercritical fluid at specified process parameters and including a reactor material acting as seed or catalyst according to the present invention, it is furthermore possible to obtain partially or wholly crystalline products at relatively low temperatures.

A supercritical fluid is used as a solvent in this process. A supercritical fluid is defined as a fluid, a mixture or an element, in a state in which the pressure is above the critical pressure (p_{c}) and the temperature is above the critical temperature (T_{c}). The critical parameters for selected fluids are shown in Table 1.

TABLE 1
Critical parameters for select inorganic and organic fluids [Jessop
et al. 1999]

| | T_{c} [° C.] | p_{c} [bar] | d_{c} [g/ml] |
|---|---|---|---|
| Inorganic Media | | | |
| Ar | −122.5 | 48.6 | 0.531 |
| CO₂ | 31.1 | 73.8 | 0.466 |
| H₂O | 374.0 | 220.6 | 0.322 |
| SF₆ | 45.5 | 37.6 | 0.737 |
| Organic Media | | | |
| Methane | −82.6 | 46.0 | 0.163 |
| Ethane | 32.2 | 48.7 | 0.207 |
| Propane | 96.7 | 42.5 | 0.220 |
| Hexane | 289.5 | 49.2 | 0.300 |
| Isopropanol | 235.3 | 47.0 | 0.273 |
| Ethanol | 243.0 | 63.0 | 0.276 |

The characteristics of a supercritical fluid are often described as a combination of the characteristics of gasses and those of liquids. As such, the supercritical fluid has the viscosity of a gas and the density of a liquid. This makes them ideal as solvents in chemical reactions. A comparison of these physical characteristics is shown in Table 2.

TABLE 2
General comparison of physical characteristics [Jessop et al., 1999]

| Characteristic | Gas | Supercritical Fluid | Liquid |
|---|---|---|---|
| Density [g/ml] | 10⁻³ | 0.3 | 1 |
| Viscosity [Pa · s] | 10⁻⁵ | 10⁻⁴ | 10⁻³ |

Due to the high density and the low viscosity the supercritical fluids are ideal for obtaining high reaction rates as well as stabilizing and controlling the sol-gel process. This results in the possibility of arresting the sol-gel process in FIG. 1 and stabilizing the particles at a size in the nano-regime of roughly 1-100 nm.

To enable the production and collection of nano-sized particles, a solid reactor filling material is introduced in the production. These filling materials can act both as seed or catalyst as well as a reservoir for collecting the nano particles. Examples of different filling material are polymers, ceramics, metal fibres, and natural materials. The filling materials can be coated and thereby have different surface properties such as hydrophilic or hydrophobic surfaces. It is believed that the reactor filling material is especially helpful in facilitating the formation of crystalline phases at low temperatures.

### Equipment and Preparation

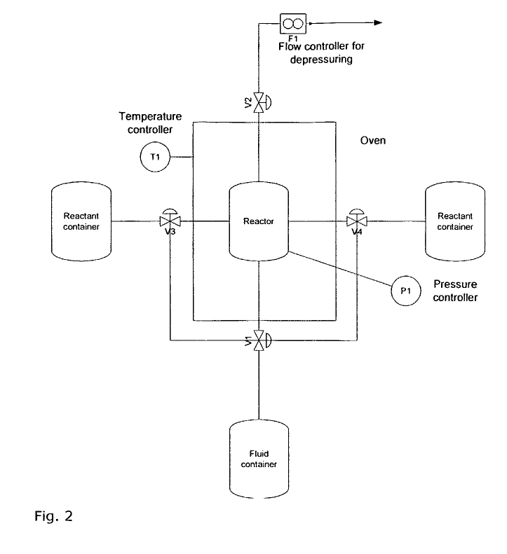

A generalized sketch of the equipment used to obtain the sub-micron product is shown in FIG. 2. Central to this equipment is the reactor in which the product is formed under supercritical conditions. The reactor is in general constructed such that both the temperature and the pressure can be controlled.

Both the metal containing precursor, the reactant/initiator/this like, the substitution source, co-solvent, the solvent and the reactor filling material are introduced into the reaction chamber. The exact order of introduction and circumstances under which these are introduced may vary substantially.

For example in one production route, which is considered to be an example of a pure batch route, the metal containing precursor, the co-solvent, and the reactor filling material may be introduced into the reaction chamber at room temperature and room pressure, albeit separated in some fashion so as to not start the hydrolysis. Once the reaction chamber is closed, the temperature and the pressure can be raised to the supercritical level by either first raising the temperature, or raising the pressure or by some more complicated combination of the two. Raising the pressure may for example be performed as a direct result of introducing the solvent, in sufficiently large quantities.

In any combination of raising the temperature and the pressure, it is paramount that supercritical conditions are reached quickly. The solvent will transport the metal containing precursor and the co-solvent until they come into contact with each other, at which time hydrolysis will commence. After some time the chamber can be depressurized, cooled and opened such that the reactor-filling material and the product which is located in proximity to the reactor filling material can be removed from the reactor.

In another example, which considered to be an example of a quasi-batch process, some of the components may be introduced into the reaction chamber at room temperature and room pressure. For example, the reactor filling material and the metal-containing precursor, may be introduced at room temperature and room pressure. In such a quasi-batch process, the temperature and the pressure may be raised in arbitrary order, or perhaps following any number of more complicated temperature pressure routes. As in the above batch process the rise in pressure may happen as a direct result of the introduction of the solvent or by any other means available in the prior art. To start the hydrolysis, it is necessary to introduce the co-solvent. This can be performed simultaneously with the introduction of the solvent, perhaps even mixing the solvent and co-solvent before introduction into the reaction chamber.

Alternatively, the introduction of the co-solvent can be performed well after the introduction of the solvent and well into the supercritical conditions. In this case the rate of hydrolysis can be controlled by the rate of co-solvent introduction into the reaction chamber. It is of course completely natural to rather consider the introduction of the reactor filling material and the co-solvent at room temperature and pressure and to consider the later introduction of the metal-containing precursor and the solvent. One may also as a further extension of the semi-batch process consider only the reactor filling material to be placed in the reactor chamber in room temperature and room pressure conditions, and for the solvent, co-solvent and metal-containing precursor to be added subsequently in preferably advantageous order and rates. After some time, the chamber can be depressurized, cooled and opened such that the reactor-filling material and the product can be removed from the reactor.

Finally, a continuous process is envisioned in which the reaction chamber is continuously (or for very long times) maintained at supercritical temperature and pressure. In such a system the introduction and extraction of reactor filling material may be continuous, or quasi-continuous as for example if a load lock system capable of introducing and removing the reactor filling material to and from the reaction chamber, while in supercritical conditions, was available.

Such a load lock system may function by introducing the reactor filling material into the load lock, closing the load lock, bringing the load lock area to conditions comparable to those in the reaction chamber, opening a valve between the reaction chamber and the load lock, introducing the reactor filling material into the reaction chamber, letting the reaction take place with the resulting product formed in proximity to reaction filling material, removing the reactor filling material from the reaction chamber into the load-lock, closing off the reaction chamber from the load lock, reducing pressure and temperature in the load lock, removing the reactor filling material (and the thereby the product) from the load-lock and subsequently taking steps to remove the product from the reactor filling materials by one or more of the means above. With two such load lock systems, production may be almost continuous by utilizing alternating load lock to introduce the reactor filling material.

In the continuous process the introduction of respectively metal-containing precursor, co-solvent and solvent can take place in any number of imaginable combinations of rates and routes to ensure the desired product characteristics.

In all of the above processing routes, one ends up with the product in proximity to the reactor filling material. In contrast to the prior art the process for separating the product from the fibre does not require a temperature treatment. In most cases it requires a simple mechanical or dynamic manipulation to separate the product from the filling material. Examples of such manipulations can be flushing in a liquid, rubbing, shaking, vibrating, jolting, sucking e.g. use of vacuum, ultrasonically agitating etc.

It is a key feature of the invention and a prerequisite for obtaining reproducible results that the chemical sol-gel process takes place in a supercritical environment. It is assumed that the reaction in the supercritical environment together with the presence of reactor fill that enables the production of, for example, the meta-stable anatase phase TiO₂ at low temperatures without the need for after treatment.

### Production Parameters and Associated Effects

By changing the process parameters it is possible to vary the characteristics of the product. In the following table various process parameters and their influence on the end product is listed.

TABLE 3
The influence of process parameters on the final product.

| Process Parameter | Effect |
|---|---|
| Temperature | Crystalline phase and density |
| Pressure | Density |
| Reactant concentration | Particle Size |
| Amount of CO₂ | Crystallinity |
| Reactor fill | Particle size and crystallinity |
| Additional supercritical drying | Crystallinity and surface area |

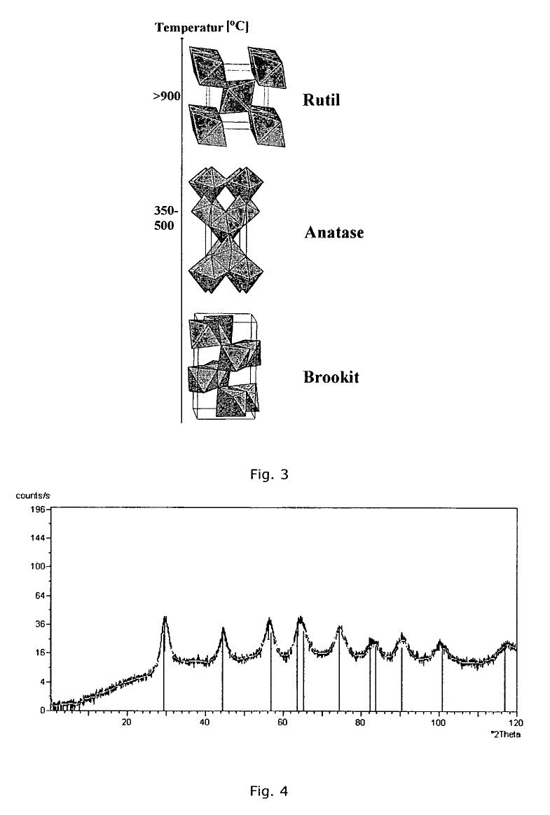

It is seen in Table 3 that by changing the temperature, it is possible to vary the crystalline phases. The lowest possible process temperature would be the temperature required to obtain a supercritical state, which for CO₂ as the supercritical fluid is, 31.1° C. Temperature has a significant influence on which phase of for example TiO₂ is produced. In FIG. 3 the crystalline phases of TiO₂ is shown as a function of temperature. It is seen that the commercially important phases of TiO₂ (anatase and rutile) normally are obtained at temperatures of respectively 350-500° C. and over 900° C. [Stojanovic et al., 2000].

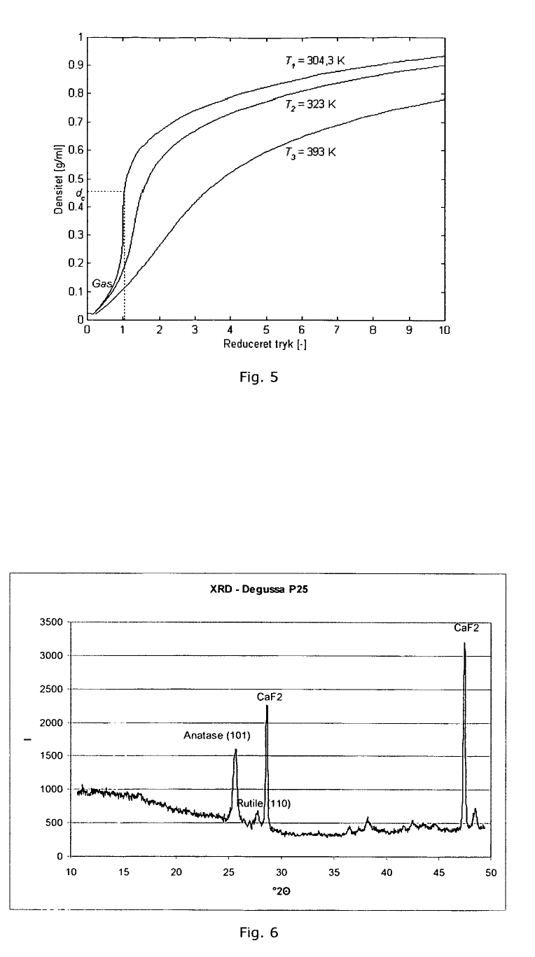

The pressure can also be varied, as long as the pressure is kept above the critical pressure that for CO₂ is 73.8 bar. By changing the pressure and temperature it is possible to change the characteristics of the solution, in terms of density. The solvent density can have a great influence on the stability of a colloidal suspension as well as on the solubility parameters for the materials in the solution. From FIG. 5 it is seen that CO₂ has a low density at normal conditions (20° C. and 1 bar), where CO₂ is a gas. Furthermore, it is seen that a significant increase in density is obtained near the critical pressure. Thus it is possible to fine-tune these parameters in order to obtain an optimal production environment.

In addition to changing the process parameters, the product can also be subjected to supercritical drying after the normal production process has taken place. Drying is done by opening valve V2 while still supplying the supercritical solvent fluid through value V1 at a given flow (F1) in a given time. The additional supercritical drying is expected to have an effect on the crystallinity as well as on the specific surface area.

### Characterization of Nano Particles

A solid can be considered as crystalline from a theoretical point of view if a Bravais lattice can describe the structure of the solid. The crystallinity of the product produced by the present method is determined by x-ray powder diffraction patterns (XRD). The patterns can be recorded by any number of standard commercial diffractometers, but were in the present case recorded using a CuKα radiation (λ=1.540 Å) from a STOE transmission diffractometer. The x-ray diffraction patterns are measured over a range of angles, which for the present case ranged from 2Θ=10° to 2Θ=50° for TiO₂ samples and from 2Θ=10° to 2Θ=80° for AlOOH samples.

The crystallinity, as used in this document, is defined with respect to a 100% reference sample, CaF₂, and the crystallinity is defined as being the background subtracted area of the 100% peak of the sample with unknown crystallinity divided by the background subtracted area of the 100% peak of the 100% crystalline CaF₂. The crystallinity ratio is compared to table values of the ratio between the respective peaks for a 100% crystalline sample and CaF₂. The sample with unknown crystallinity and CaF₂ are mixed with a weight ratio of 50%.

It is in the following shown how the crystallinity of a TiO₂ sample is determined. The ratio between the background subtracted area of the 100% peak for anatase (101) and corundum in a 50% weight ratio is:

$$\frac{{A}_{Anatase , 101}}{{A}_{Corundum}} = 5.00$$

And the ratio between the 100% peak of CaF₂ and corundum in a 50% weight ratio is:

$$\frac{{A}_{{CaF}_{2} , 220}}{{A}_{Corundum}} = 4.00$$

This gives a ratio between 100% crystalline anatase and CaF₂ in a 50% weight ratio is:

$$\frac{{A}_{Anatase , 101}}{{A}_{CaF 2 , 220}} = 1.25$$

This method can be demonstrated for Degussa P25 from Degussa GmbH, Germany, which is a commercial TiO₂ powder prepared by the flame oxidation synthesis and consists of both the anatase phase as well as the rutile phase. The ratio between rutile (110) and CaF₂ is 0.85.

The sample is mixed in a weight ratio of 50% with CaF₂. The diffraction pattern for the determination of the crystallinity of Degussa P25 is shown in FIG. 6. As shown on FIG. 6 Degussa consists of both the anatase as well as the rutile phase of TiO₂. By analyzing the measured spectra from Degussa P25 powder and calculating the area of the peaks gives a fraction of 71% crystalline anatase phase and 27% crystalline rutile phase while the remaining 2% is an amorphous fraction. This is in agreement with [Pozzo et al., 2002] who have measured the Degussa P25 powder to consist of 75% anatase and 25% rutile and [Porter et al., 1999] who got 76.5% anatase and 23.5% rutile. [Porter et al., 1999] also report about an amorphous fraction in the Degussa P25 powder.

The x-ray powder diffraction patterns are also used to determine the crystallite size, τ, or primary particle size of the sample from Scherer's formula [Jenkins et al., 1996]:

$$τ = \frac{K \cdot λ}{{β}_{τ} \cdot cos θ}$$

### Where:

K=Form factor=0.9
β_{τ}=Width of the peak at half the maximum intensity subtracted from instrumental noise
Θ=Diffraction angle

The crystallite size of Degussa P25 for the (101) peak is 35 nm.

The size of the primary particles, which can be different than the size of the crystallites determined above, can be determined by scanning electron microscopy (SEM) and Small-Angle X-ray Scattering (SAXS).

The SAXS data can be obtained using any number of commercial or home-built systems, but in the present case was obtained using an adaptation of a Brukers AXS, Nanostar SAXS system, with a rotating anode x-ray generator, Cross-coupled Goebel mirrors and a Bruker AXS Hi-star Area Detector.

The scattering intensity, I, was measured in terms of the scattering vector modulus q=4n sin (Θ))/λ, where λ=1.54 Å. The scattering intensity was measured from q=0.0071 Å⁻¹ to q=0.334 Å⁻¹. The data was corrected for background and azimuthally averaged to obtain a spectrum of average intensity vs. q. The data was then analyzed by fitting to the Beaucage model [Beaucage and Schaefer, 1994]:

$$\frac{I ( q )}{{I}_{0}} G \cdot exp ( \frac{- {q}^{2} \cdot {R}_{g}^{2}}{3} ) + B \cdot {[ ( {erf ( \frac{q \cdot {R}_{g}}{\sqrt{6}} )}^{3} ) / q ]}^{P}$$

### Where:

R_{g}: Radius of gyration
P: Mass fractal dimension
B: Pre-factor specific to the type of power-law scattering, specified by the regime in which the exponent P, falls
G: Classic Guinier pre-factor

The Beaucage model gives information of the size of the primary particle through the radius of gyration. The radius of gyration is defined as the weight average radius of the particles. In difference from XRD data SAXS can determine the size of primary particles of both crystalline as well as amorphous samples.

A Sorptomatic 1990 from ThermoQuest is used to determine the specific surface area of the produced powder. The apparatus measures the adsorption isotherm of nitrogen on the sample and calculates the surface area from this isotherm.

### Example 1

### Production of Nano-Sized TiO₂

In this example the production of nano-sized crystalline TiO₂ by a batch process is described. The precursor in this example is a 97% titaniumtetraisopropoxide, Ti(OPrⁱ)₄, from Sigma Aldrich. It will in the following be referred to as TTIP. The TTIP reacts with distilled water in a supercritical environment including reactor filling material acting as seeds or catalyst material. The supercritical fluid is in this example CO₂. The experimental set up is shown in FIG. 2 and the batch process is generically described in the Equipment and Preparation section.

The process equipment consists of a reactor where the supercritical sol-gel reaction takes place. The reactor in this example comprises reactor filling material in the form of fibres. The reactor is placed in an oven where the pressure and temperature can be controlled. The pressure can be changed from 1-680 bars depending on the desired product and is controlled by a pump (P1). The temperature can be changed from 25-250° C. and is controlled by a temperature regulator (T1). The setup is a Spe-ed SFE-2 from Applied Separation Inc.

In the batch experiment the supercritical reactor is first filled with reactor filling material. The TTIP is than injected in the top of the reactor into the reactor filling material and the water is injected in the bottom of the reactor into the reactor filling material. The amount of reactor filling material is adjusted as to prevent the reaction to take place before the CO2 is added to the reactor. The reactor is than placed in the preheated oven at 96° C. The CO₂ is added immediately having an entering temperature of 1.3° C. and a pressure of 60 bar. The pressure is raised to the starting set point, 100 bar. The temperature in the reactor is reaching the set point in 30 minutes. As a result of the increasing temperature of the reactor, from room temperature to 96° C., the pressure is increasing from 100 bar to approximately 170-200 bar in 30 minutes. The experimental parameters and the reactants amount for a standard experiment for TiO₂ is shown in table 4.

TABLE 4
Standard experiment

| | | Reaction | | | Reactor filling |
|---|---|---|---|---|---|
| Temperature | Pressure | time | V_{TTIP} | V_{H2O} | material |
| 96° C. | 100 bar | 4 hours | 2.10 ml | 1.00 ml | Hydrophilic PP |

The amount of TTIP in a standard experiment is 2.10 ml and the amount of distilled water is 1.00 ml that gives a hydrolysis ratio on 7.87. The filling material used is hydrophilic polypropylene polymer fibres (PP).

The standard experiment with the above process parameters has, according to the present invention, enabled the production of a pure anatase phase TiO₂. This is shown in FIG. 4, where an x-ray diffraction spectrum of a powder produced using the above equipment and method is shown. In the figure, the spectrum of the product is compared to diffraction lines expected from pure anatase. It is seen that except for broadening, which is due to the small size of the crystalline particle the observed lines coincide with those expected from anatase. No other TiO₂ phases are present. The crystallite size, τ, of this production run has been determined to be approximately 10 nm. The following table shows the characteristic results of materials produced by the above preparation method and process parameters.

TABLE 5
Characteristics of TiO₂ powders produced by standard experiments

| | Standard experiment |
|---|---|
| Crystalline phase | Anatase |
| τ [nm] | 10.7 ± 1.0 |
| Crystallinity [%] | 40.0 ± 5.0 |
| Particle size by SAXS [nm] | 12.6 ± 1.0 |
| Particle size by SEM [nm] | ~20 ± 5 |
| Specific surface area [m²/g] | 236 ± 20 |

Table 5 shows that the result obtained by the present invention. The crystallinity of the product is 40±5% over a series of 5 experiments. The remaining part is amorphous TiO₂. The average particle size estimated by the crystallite size is 10.7±1.0 nm. Both particle size and crystallinity were derived from spectra like the one shown in FIG. 8. The SAXS measurement confirms that the powder consist of primary particle of 10-15 nm. The SEM analysis also reveals that the samples are made out of nano-sized primary particles in a range from 15-25 nm. These primary particles are then agglomerated into larger aggregates. The BET measurement shows that the samples have a large surface area of 236 m²/g.

### Example 1A

### Production of TiO₂ With Changing Reaction Times

In the following example the consequence of changing the process time is described. The experiment is a standard experiment as described in example 1 but the reaction time is changed. In the following table the influence of changing the process time is shown.

TABLE 6
Characteristics of TiO₂ powders produced at different reaction times

| | 2 hours | 4 hours | 8 hours |
|---|---|---|---|
| Crystalline Phase | Anatase | Anatase | Anatase |
| τ [nm] | 8.5 | 10.7 | 10.7 |
| Crystallinity [%] | 39.5 | 40.0 | 39.4 |

By changing the reaction time the primary particle size changes slightly from 2 to 4 hours but does not change from 4 to 8 hours. The increase of the reaction time does not result in an increase of the crystallinity of the samples. The crystallinity is at all reaction times approximately 40%.

### Example 1B

### Production of TiO₂ at 43° C.

In this example a standard experiment is carried out as described in example 1 but the temperature is lowered to 43° C. The results from this experiment is shown in table 7

TABLE 7
Characteristics of TiO₂ powders produced at 43° C.

| | TiO₂ |
|---|---|
| Crystalline phase | Amorphous |
| τ [nm] | — |
| Crystallinity | Amorphous |
| R_{g} [nm] | 2.8 |

It is shown in table 7 that the powder is amorphous when produced at 43° C. The size of the primary particles is determined by SAXS and is as low as 5.6 nm in diameter.

### Example 2

### Production of TiO₂ With Different Reactor Filling Material

In this example the influence of different reactor filling material is investigated. 5 different filling materials are examined and the influence on the product properties is determined. The reactor filling material is divided into 4 categories: polymers (in form of fibres), ceramics (in form of small balls), metals (in form of steel wool) and natural material (a sheet of flax). Two polypropylene (PP) polymers with different surface properties are investigated.

Ten standard experiments, like those described in example 1, were carried out. Five different reactor filling materials were used and the amount was adjusted separately. For each experiment the amount was determined so the reactants did not react before the supercritical CO₂ was added. In table 8 the results from these experiments are shown. The results are average values from the 2 experiments for each material.

TABLE 8
Measured properties of produced TiO₂
with different filling materials

| | PP hydrophilic | PP hydrophobic | Ceramic | Metal fibre | Natural fibre |
|---|---|---|---|---|---|
| Crystal phase | Anatase | Anatase | Anatase | Anatase | Anatase |
| Crystallinity [%] | 40.0 ± 5.0 | 32.4 ± 4.0 | 28.0 ± 5.5 | 25.7 ± 5.5 | 16.0 ± 4.0 |
| Crystal size [nm] | 12.4 ± 2.0 | 13.0 ± 2.0 | 13.4 ± 2.0 | 12.6 ± 2.0 | 18.5 ± 5.0 |

From table 8 it can be seen that the highest crystallinity comes from using the hydrophilic PP as reactor filling material. It gives 40% crystalline TiO₂ on anatase phase. The natural material is not so applicable for producing crystalline TiO₂, only 16% anatase phase. In between is the hydrophobic PP, the ceramic and metal fibres. These 3 reactor filling materials gives all around 25-33% crystalline TiO₂ and because of uncertainties it is not possible to distinguish between these 3 reactor filling materials regarding crystallinity. It can also be seen that these 3 materials plus the hydrophilic PP gives the same crystal size of 12.4 to 13.4 nm. The natural material gives a larger crystal size of 18.5 nm. The larger crystallite size is due to bigger uncertainties in determining the peak parameters resulting from a smaller peak. From the results in table 8 it is shown that using these 5 materials all give crystalline TiO₂ at anatase phase.

### Example 3

### Production of Al₂O₃

In this example the production of nano-sized Al₂O₃ by a batch process is described. The precursor in this example is aluminium-sec-butoxide, Al(OBu^{s})₃, from Sigma Aldrich. The hydrophilic polypropylene fibres are used as reactor filling material. The reactor filling material, Al(OBu⁵)₃ and water is placed in the reactor before inserting it in the oven and the experiment is carried out as in example 1. In table 9 the process parameters and reactant amount are shown.

TABLE 9
Al₂O₃ experiment

| | | Reaction | | | Reactor filling |
|---|---|---|---|---|---|
| Temperature | Pressure | time | V_{Al(OBus)3} | V_{H2O} | material |
| 96° C. | 100 bar | 4 hours | 2.10 ml | 1.00 ml | Hydrophilic PP |

The reactant amounts give a hydrolysis ratio of 6.8. The produced material is nano-sized and weak crystalline. The particle properties are shown in table 10.

TABLE 10
Characteristics of Al₂O₃ powders

| | Al₂O₃ |
|---|---|
| Crystallinity | Weak |
| R_{g} [nm] | 9.7 |

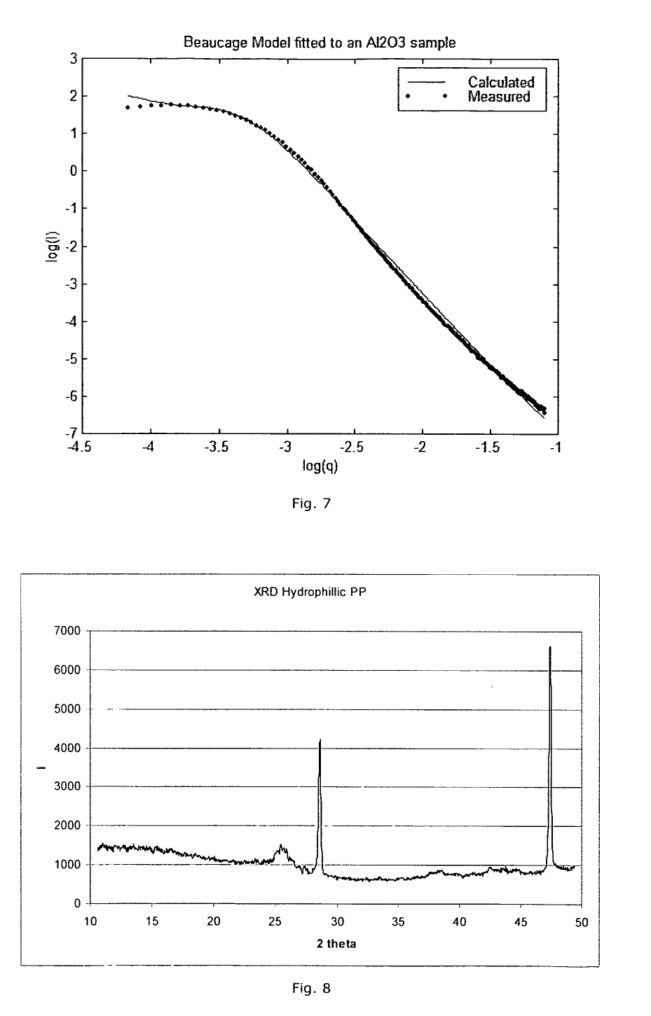

The size of the primary particle is determined by SAXS measurement which yields a diameter of 19.4 nm. The SAXS spectrum is shown in FIG. 7.

### Example 3A

### Production of Al₂O₃ at 173° C.

In this example Al203 is produced at a higher temperature and hydrolysis ratio than example 3. A batch process makes the production and the precursor in this example is aluminium-sec-butoxide, Al(OBu⁵)₃, from Sigma Aldrich.

The metal fibre is used as reactor filling material. The reactor filling material, Al(OBu⁵)₃ and water is placed in the reactor before inserting it in the oven and the experiment is carried out like example 1. In table 11 the process parameters and reactant amounts are shown.

TABLE 11
Al₂O₃ experiment

| | | Reaction | | | Reactor filling |
|---|---|---|---|---|---|
| Temperature | Pressure | time | V_{Al(OBus)3} | V_{H2O} | material |
| 173° C. | 100 bar | 4 hours | 0.96 ml | 2.00 ml | Metal fibre |

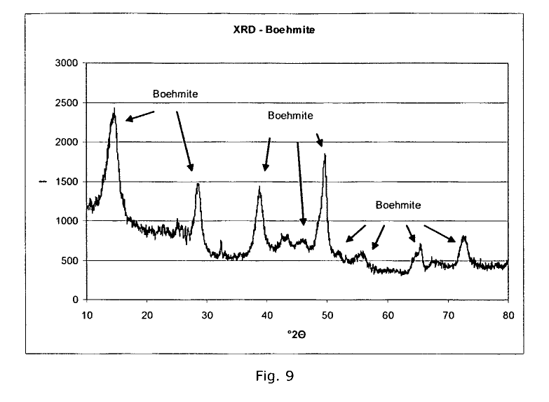

The reactant amounts give a hydrolysis ratio of 29.9. The produced material is nano-sized and consists of the crystalline aluminium oxide hydroxide phase Boehmite. The characteristics of the produced powder are shown in table 12 and the diffraction spectrum is shown in FIG. 9.

TABLE 12
Characteristics of AlOOH powders produced at 173° C.

| | AlOOH |
|---|---|
| Crystalline phase | Boehmite |
| τ_{28.4°2⊖} [nm] | 12.7 |
| Crystallinity | 93.5% |

The powder consists of 94% crystalline Boehmite the main remaining part is amorphous powder but the powder also consists of a small fraction of aluminium transitions oxide/hydroxide phase. The crystals are 12.7 nm in dimensions determined by Scherrers formula.

### REFERENCES

[Andersen, 1975]
J. R. Andersen.

Structure of Metallic Catalysts.

Acedemic Press, 1975.
[Beaucage and Schaefer, 1994]
Beaucage, G. and D. W. Schaefer.
“Structural studies of complex systems using small angle scattering: a unified GuinierIpower law approach.”
Journal of Non-Crystalline Solids 172-174: 797-805, (1994).
[Brinker et al., 1990]
C. Jeffrey Brinker, George W. Scherer.
Sol-gel Science, The Physics and Chemistry of Sol-Gel Processing
Academic Press 1990.
[Jenkins et al., 1996]

Ron Jenkins and Robert L. Snyder.

Introduction to X-ray Powder Diffractometry.

John Wiley & Sons, Inc., 1996.
[Jessop et al., 1999]

Philip G. Jessop and Walter Leitner.

Chemical Synthesis Using Supercritical Fluids.

Wiley-VCH, 1999.
[Livage et al., 1988]

J. Livage, M. Henry and C. Sanchez.

Sol-Gel Chemistry of Transition Metal Oxides.

Progress in Solid State Chemistry, 18 (4), 259-342, 1988.
[Moran et al., 1999]
Paul D. Moran, John R. Bartlett, Graham A. Bowmaker, James L. Woolfrey, Ralph P. Cooney.
Formation of TiO₂ Sols, Gels and Nanopowders from Hydrolysis of Ti(OⁱPr)₄ in AOT Reverse Micelles.
Journal of Sol-Gel Science and Technology 15, 251-262, 1999.
[Porter et al., 1999]
Porter, J. F., Y.-G. Li and C. K. Chan.
“The effect of calcination on the microstructural characteristics and photoreactivity of degussa P-25 TiO₂.”
J. Mat. Sci 34: 1523-1531 (1999).
[Pozzo et al., 2002]
Pozzo, R. L., A. E. Cassano and M. A. Baltanas. “The Performance in Fluidized Bed Reactors of Photo catalysts Immobilized onto Inert Supports.”
http://www.unl.edu.ar/cepac/abstract/bbaltana.htm. (2002)
[Soloviev, 2000]
Soloviev, A.
Sol-Gel Process: Study of the Kinetics of Particle Growth by Light Scattering Technique. Ph.D. Thesis, Université Paris Nord, (2000).
[Stojanovic et al., 2000]

B. D. Stojanovic, Z. V. Marinkovic, G. O. Brankovic and E. Fridancevska. Evaluation of Kinetic Data for Crystallization of TiO₂ prepared by Hydrolysis Method. Jour. of Thermal Analysis and Calorimetry, Vol. 60, 595-604, 2000.
Andrievski, R. A. (1997). “Films of Interstitial Phases: synthesis and properties.” Journal of material science 32: 4463-4484.
Andrievski, R. A. (2003). “Stability of nanostructured materials.” Journal of material science 38: 1367-1375.
Gallo, T. A. and C. C. Greco. “Metal Carbide Production from Carboxylate Precursors.” U.S. Pat. No. 5,169,808. (1992).

Koc, R. and J. S. Folmer (1997). “Carbothermal synthesis of titanium carbide using ultrafine titania powders.” Journal of material science 32: 3101-3111.

Koc, R. and G. C. Glatzmaier. “Process for synthesizing titanium carbide, titanium nitride and titanium carbonitride.” U.S. Pat. No. 5,417,952. (1995).
Komarneni, S., I. R. Abothu and A. V. P. Rao (1999). “Sol-Gel Processing of Some Electroceramic Powders.” Journal of Sol-Gel Science and Technology 15: 263-270.
Krishnan, G., M. Gusman, S. M. Johnson, D. J. Rowcliffe and H. Nakano. “Production of Metal Carbides.” U.S. Pat. No. 4,886,652. (1989).
Li, X. K., L. Liu, S. Ge, S. D. Shen, J. R. Song, Y. X. Zhang and P. H. Li (2001). “The preparation of Ti(C,N,O) nanoparticles using binary carbonaceous titania aerogels.” Carbon 39: 827-833.
Nanostructured and Amorphous Material, I. (2003). The website of Nanostructured and Amorphous Material, Inc., www.nanoamor.com, 18 Nov. 2003.
Ogawa, T. and K. Fukuda (1993). “Transition metal carbide and boride through alkoxide gelation.” International Journal of Material and Product Technology 8 (2): 476-483.
Pierre, A. C. (1998). Introduction to sol-gel processing. Kluwer Academic Publishers.
Preiss, H., E. Schierhorn and K. W. Brzezinka (1998). “Synthesis of polymeric titanium and zirconium precursors and preparation of carbide fibres and films.” Journal of material science 33: 4697-4706.
Rayner-Canham, G. and T. Overton (2003). Descriptive Inorganic Chemistry. W. H.

Freeman and Company.

Schiøtz, J. and T. Vegge (1999). “Computer simulations of the mechanical properties of metals.” Science Progress 82 (4): 313-325.
Beltrán, H., N. Masó, B. Julian, E. Cordoncillo, J. B. Carda and P. Escribano (2003). “Preparation and Characterization of Compositions Based on PbO—MgO—Nb2O5 Using Sol-Gel Method.” Journal of Sol-Gel Science and Technology 26: 1061-1065.
Kim, J. and Y. S. Lin (1998). “Sol-gel synthesis and characterization of yttria stabilized zirconia membranes.” Journal of Membrane Science 139: 75-83.
Komarneni, S., I. R. Abothu and A. V. P. Rao (1999). “Sol-Gel Processing of Some Electroceramic Powders.” Journal of Sol-Gel Science and Technology 15: 263-270.
Paik, D. S., A. V. P. Rao and S. Komarneni (1997). “Ba Titanate and Barium/Strontium Titanate Thin Films from Hydroxide Precursors: Preparation and Ferroelectric Behavior.” Journal of Sol-Gel Science and Technology 10: 213-220.
Poosanaas, P., A. Dogan, A. V. Prasadarao, S. Komarneni and K. Uchino (1997). “Photostriction of Sol-Gel Processed PLZT Ceramics.” Journal of Electroceramics 1:1: 105-111.
Rao, A. V. P., D. S. Paik and S. Komarneni (1998). “Sol-gel Synthesis of Litium Niobate Powder and Thin Films Using Lithium 2,4-Pentanedionate as Lithium source.” Journal of Electroceramics 2:3: 157-162.
Traversa, E., M. L. Di Vona and S. Licoccia (2001). “Sol-Gel Processed TiO2-Based Nano-sized Powders for use in Thick-Film Gas Sensors for Atmospheric Pollutant Monitoring.” Journal of Sol-Gel Science and Technology 22: 167-179.
Wu, A., I. M. M. Salvado, P. M. Vilarinho and J. L. Baptista (1997). “Processing and Seeding Effects on Crystallisation of PZT Thin Films from Sol-Gel Method.” Journal of European Ceramic Society 17: 1443-1452.

1. Method of manufacturing a metal and/or semi-metal compound such as metal and/or semi-metal oxides, metaloxy and/or semi-metaloxy hydroxides metal and/or semi-metal hydroxides, metal and/or semi-metal carbides, metal and/or semi-metal nitrides, metal and/or semi-metal carbonitrides, metal and/or semi-metal borides, electroceramics and other such compound, said compound having a sub-micron primary particle size, comprising the steps of:
introducing a solid reactor filling material in a reactor,
introducing a metal- and/or semi-metal-containing precursor or a substitution source in said reactor,
introducing a reactant into said reactor,
introducing a supercritical solvent into the said reactor, thereby
establishing a contact between the metal- and/or semi-metal-containing precursor and the co-solvent, thus
resulting in the formation of said compound in the proximity of the said solid reactor filling material.

2-5. (canceled)

6. Method according to claims 1, wherein the formation of said compound takes place by a process involving at least a sol-gel reaction.

7. Method according to claim 1, wherein the metal and/or semi-metal compound is/are substantially crystalline.

8. (canceled)

9. Method according to claim 1, wherein the metal and/or semi-metal compound is/are substantially amorphous.

10. (canceled)

11. Method according to claim 1, wherein the metal and/or semi-metal compound is/are a mixture of several different phases.

12. (canceled)

13. Method according to any of claims 1-5, wherein the introduction of the solid reactor filling material, the metal-containing precursor, alternatively the semi-metal precursor, the possible co-solvent, and the supercritical solvent into the said reactor is done in arbitrary order.

14. (canceled)

15. Method according to any of claims 1-5, wherein at least one of the solid reactor filling material, the metal-containing precursor, alternatively the semi-metal-containing precursor, the possible co-solvent or the supercritical solvent is mixed with at least one of the solid reactor filling material, the metal-containing precursor, alternatively the semi-metal-containing precursor, the possible co-solvent or the supercritical solvent before introduction into the said reactor.

16. (canceled)

17. Method according to any of claims 1-5, where the reactant comprises at least one of the following components: water, ethanol, methanol, hydrogenperoxid and isopropanol.

18. Method according to any of claims 1-5, where the substitution source comprises at least one of the following components: carbon, nitrogen, boron and/or any combination of these.

19-23. (canceled)

24. Method according to any of claims 15, wherein a temperature in the reactor during the formation of said compound is performed at a temperature profile being an arbitrary combination at least two of the temperature profiles: a fixed temperature, an increasing temperature, a decreasing temperature.

25. Method according to claim 10, wherein the temperature in the reactor during the formation of said compound is maximum 400° C., more preferably maximum 300° C., even more preferably maximum 200° C., most preferably maximum 100° C., and even and most preferably maximum 50° C.

26-28. (canceled)

29. Method according to any of claim 1-5, wherein a pressure in the reactor during the formation of said compound is performed at a pressure profile being an arbitrary combination at least two of the pressure profiles: a fixed pressure, an increasing pressure, a decreasing pressure.

30. Method according to any of claims 15, wherein the supercritical solvent is CO₂, and wherein the pressure in the reactor during the formation of said compound is minimum 74 bar, more alternatively minimum 80 bar, even more alternatively minimum 90 bar, and most alternatively minimum 100 bar and wherein the temperature in the reactor during the formation of said compound is minimum 31° C., alternatively 43° C., alternatively minimum 100° C., alternatively minimum 200° C., alternatively minimum 300° C., alternatively minimum 400° C. alternatively minimum 500° C., alternatively minimum 600° C., alternatively minimum 700° C., alternatively minimum 800° C.

31. (canceled)

32. Method according to any of claims 1, wherein the supercritical solvent is isopropanol, and wherein the pressure in the reactor during the formation of said compound is minimum 47 bar, more alternatively minimum 80 bar, even more alternatively minimum 90 bar, and most alternatively minimum 100 bar and wherein the temperature in the reactor during the formation of said compound is minimum 235° C., more alternatively minimum 250° C., even more alternatively minimum 270° C., most alternatively minimum 300° C., and even and most alternatively minimum 400° C.

33-35. (canceled)

36. Method according to any of claims 15, wherein the time of the formation of said compound is maximum 1 hour, preferably maximum 0.75 hour, and most preferably maximum 0.5 hour.

37. (canceled)

38. (canceled)

39. Method according to any of claims 1 -5 wherein a plurality of different metal- and/or semi-metal-containing precursors is/are introduced in said reactor.

40-42. (canceled)

43. Method according to any of claims 1 -5, wherein the metal containing or semi-metal containing precursor is a metal alkoxide or a semi-metal alkoxide.

44-50. (canceled)

51. Method according to any of claims 2-5, wherein the co-solvent is selected from the group of: water, ethanol, methanol, hydrogenperoxid and isopropanol.

52. Method according to any of claims 2-5, wherein a plurality of different co-solvents is introduced in said reactor.

53-91. (canceled)

92. Method according to any of claims 1-5, wherein the solid reactor filling material comprises any combination of metal oxide, semi-metal oxide, metal oxidhydroxide, semi-metal oxidhydroxide, metal hydroxide, semi-metal hydroxide, metal carbide, semi-metal carbide, metal nitride, semi-metal nitride, metal carbonitride, semi-metal carbonitride, metal boride and semi-metal boride identical to at least one compound resulting from the formation in said reactor.

93. Method according to any of claims 1-5, wherein the solid reactor filling material functions as seed material for the formation of said compound and/or as a collecting agent for the said compound.

94-96. (canceled)

97. Method according to any if claims 1-5, wherein said compound is separable from the solid reactor filling material in a way that allows the solid reactor filling material to be reused as solid reactor filling material.

98. Method according to any of claims 1-5, wherein said compound is separable from the solid reactor filling material by flushing the solid reactor filling material in a fluid or by vacuum means or by blowing means or by ultrasonic means.

99-102. (canceled)

103. Metal compound such as metal and/or semi oxide, metal and/or semi oxidhydroxide, metal and/or semi hydroxide, metal and/or semi carbide, metal and/or semi nitride, metal and/or semi carbonitride or metal and/or semi boride compound being manufactured by the method according to any of claims 1-5, wherein the metal and/or semi oxide, metal and/or semi oxidhydroxide, metal and/or semi hydroxide, metal and/or semi carbide, metal and/or semi nitride, metal and/or semi carbonitride or metal and/or semi boride compound is in the form of aggregates of primary particles with an average primary particle size of 100 nm, preferably maximum 50 nm, more preferably maximum 20 nm, and most preferably maximum 10 nm.

104-111. (canceled)

112. Apparatus for manufacturing a metal and/or semi-metal compound such as metal and/or semi-metal oxides, metaloxy and/or semi-metaloxy hydroxides metal and/or semi-metal hydroxides, metal and/or semi-metal carbides, metal and/or semi-metal nitrides, metal and/or semi-metal carbonitrides, metal and/or semi-metal borides, electroceramics and other such compound, said compound having a sub-micron primary particle size, comprising the following components:
means for introducing a solid reactor filling material in a reactor,
means for introducing a metal- and/or semi-metal-containing precursor in said reactor,
means for introducing a reactant in said reactor,
means for introducing a supercritical solvent into the said reactor,
said reactor intended as a space for establishing a contact between the metal- and/or semi-metal-containing precursor and the reactant and
said reactor intended as a space for the formation of said compound in the proximity of the said solid reactor filling material.

113. (canceled)

114. Apparatus for manufacturing a metal and/or semi-metal compound such as metal and/or semi-metal oxides, metaloxy and/or semi-metaloxy hydroxides, metal and/or semi-metal hydroxides, metal and/or semi-metal carbides, metal and/or semi-metal nitrides, metal and/or semi-metal carbonitrides, metal and/or semi-metal borides, electroceramics and other such compound, said compound having a sub-micron primary particle size, comprising the following components:
means for introducing a solid reactor filling material in a reactor,
means for introducing a metal- and/or semi-metal-containing oxide in said reactor,
means for introducing a substitution source mi said reactor,
means for introducing a supercritical solvent into the said reactor,
said reactor intended as a space for establishing a contact between the metal- and/or semi-metal-containing oxide and the substitution source and
said reactor intended as a space for the formation of said compound in the proximity of the said solid reactor filling material.

115. (canceled)
